(19) United States
(12) Patent Application Publication
(10) Pub. No.: US 2007/0274314 A1
(43) Pub. Date: Nov. 29, 2007

(54) System and method for creating application groups

(76) Inventors: Ryan A. Werber, Burnaby (CA); Peter J. Wood, Burnaby (CA); Eric S. Pridham, Vancouver (CA)

Correspondence Address: PATTON BOGGS LLP, 8484 WESTPARK DRIVE, SUITE 900, MCLEAN, VA, 22102, US

(21) Appl. No.: 11/438,848

(22) Filed: May 23, 2006

(51) Int. Cl. H04L 12/56

(52) U.S. Cl. 370/392

(57) ABSTRACT

A method of forming an application group includes selecting a plurality of applications to be associated with an identifier and determining at least one rule associated with the identifier. The rule is operable to define at least one operation of a network device that is conducted in response to the network device receiving data associated with one of the plurality of applications.

### BACKGROUND OF THE INVENTION

1. Field of the Invention

This invention relates in general to the field of telecommunications, and more particularly to a system and method for creating application groups.

2. Description of Related Art

Existing routers require significant expertise to configure them when they are connected to a network. Such expertise can sometimes only be obtained through costly training offered by a router's manufacturer or by employing a highly skilled network engineer.

### SUMMARY OF THE INVENTION

In accordance with the present invention, a system and method for creating application groups is disclosed that minimizes the expertise required to configure a router for use on a network.

In one embodiment of the present invention, a method of forming an application group is disclosed that includes selecting a plurality of applications to be associated with an identifier and determining at least one rule associated with the identifier. The rule is operable to define at least one operation of a network device that is conducted in response to the network device receiving data associated with one of the plurality of applications.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is an embodiment of a network for which a router may be configured according to the teachings of the present invention;

FIG. 2 is an additional embodiment of a network for which a router may be configured according to the teachings of the present invention;

FIG. 3 is an embodiment of a process for configuring a router according to the teachings of the present invention;

FIG. 4 is an additional embodiment of a process for configuring a router according to the teachings of the present invention;

FIG. 5 is an additional embodiment of a process for configuring a router according to the teachings of the present invention;

FIG. 6 is an embodiment of a process for creating an application group according to the teachings of the present invention;

FIG. 7 is an embodiment of a process for configuring a router using an application group according to the teachings of the present invention;

FIG. 8 is an embodiment of a process for creating a quality of service class for an application group;

FIG. 9 is an embodiment of a tree-structure utilized to obtain the configuration of a network device according to the teachings of the present invention; and

FIG. 10 is an embodiment of a process for reconfiguring a router without rebooting the router.

### DETAILED DESCRIPTION OF THE PRESENT INVENTION

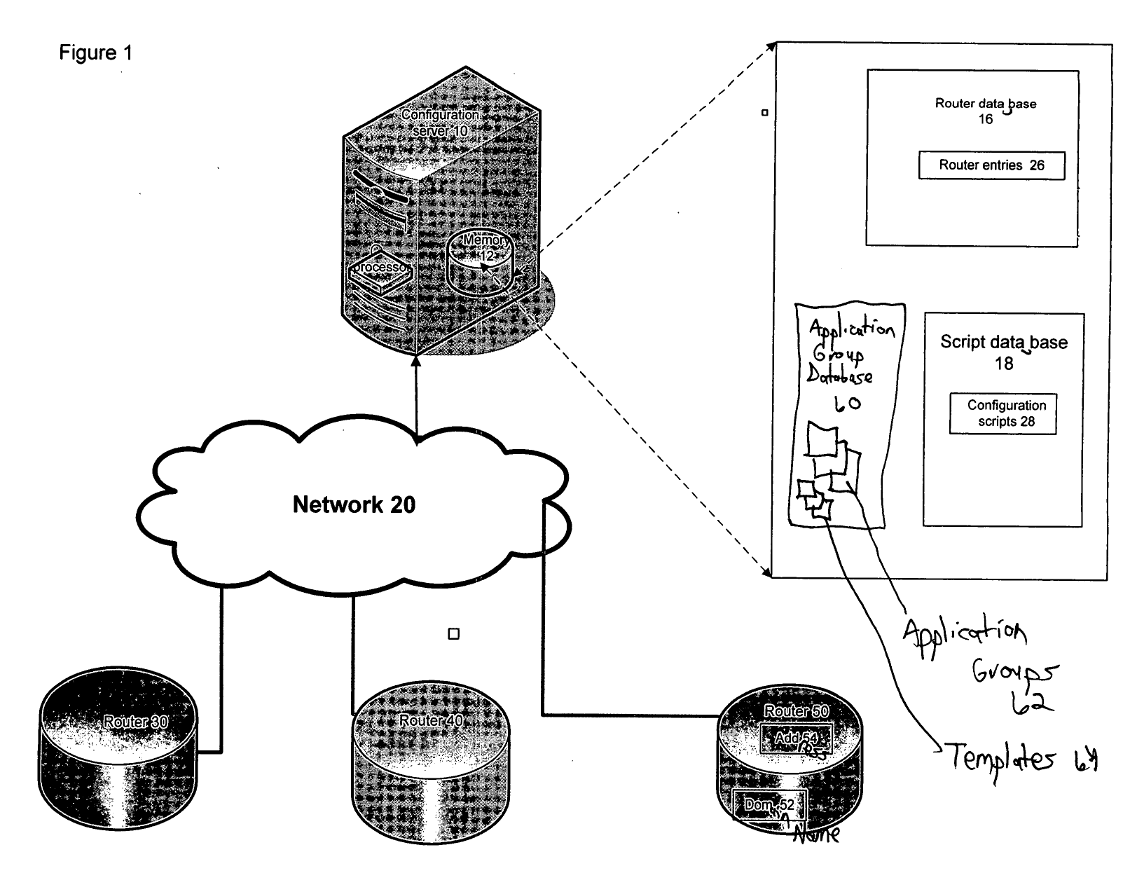

FIG. 1 illustrates a network 20 over which a router 50 may be configured to operate using a configuration script communicated from a configuration server 10 over network 20. Such configuration of router 50 using a configuration script received from configuration server 10 allows router 50 to be automatically configured in response to being physically connected to network 20 and communicating with configuration server 10.

Configuration server 10 may be any suitable server capable of providing data or applications over network 20 to network elements such as router 50, clients or other devices utilizing network 20. In one embodiment, configuration server 10 is a server that includes memory and processing components necessary to store information about one or more routers such as router 50 and one or more configuration scripts for automatically configuring a router such as router 50. However, configuration server 10 may also serve as a web server, a DHCP server, or any other network server performing the functionality of any or all of the foregoing, either alone or in combination with additional functionality. Configuration server 10 may include one or more specialized or general-purpose computing platforms having processing components, memory, and communication interfaces sufficient to interact with and communicate data over network 20. Certain components of configuration server 10 are identified according to functional purpose such as router database 16 described below. Such components may be accessed or executed using the same or different software routines stored in one or more memory components and executed using one or more processing components including but not limited to a memory 12 and a processor 14 respectively.

Memory 12 may be any suitable combination of volatile or nonvolatile memory, addressed using any suitable addressing scheme, and present in one or more separate or integrated physical devices. Processor 14 may be any suitable combination of hardware and software, including without limitation, one or more microprocessors, microcontrollers, ASICs, or software engines.

Memory 12 includes a router database 16, a script database 18, and an application group database 60. Router database 16 is a database that stores information about one or more routers such as router 50 used or intended to be used in network 20. More particularly, router database 16 may include one or more router entries 26. Each router entry 26 may include various information about a router that is connected to the network or intended to be connected to the network. Such information may include but is not limited to, a static IP address, a dynamic IP address, a static gateway, a dynamic gateway, a static subnet address, a dynamic subnet address, firewall information, port information, or any other suitable network, connection, protocol, or device information, and may also include any additional information that may be useful to configuration server 10 in configuring, managing a connection with, or otherwise determining rules for a router such as router 50.

Script database 18 includes one or more configuration scripts 28. Such configuration scripts 28 may be a script corresponding to a particular router such as router 50 that is either connected to or intended to be connected to network 20. Configuration scripts 28 may also include configuration scripts that are templates such as model scripts or libraries of portions of scripts used by configuration server 10 to generate new configuration scripts 28 for routers such as router 50. In particular, each of configuration scripts 28 includes one or more commands that are executable by a router such as router 50 in order to configure such router to operate over a network such as network 20. Such commands may include commands necessary to configure the firewall rules or the port forwarding rules of a router such as router 50. Alternatively, a particular configuration script 28 may instead include one or more identifiers associated with a command that are recognizable by a router such as router 50 and used by such router to execute a command corresponding to such identifier.

Configuration scripts 28 may also include commands used to implement routing rules. Routing rules may be specific routing commands. For example, a routing rule may include a command that addresses in a specified range of addresses should be forwarded to port 7 instead of port 1. Routing rules may also include load-balancing commands or other suitable commands not specific to particular addresses. For example, a routing rule may include a command that each stateful connection should be made in an alternating manner on ports 1 through 3, or a command that connectionless packets be sent from the ports in a round-robin fashion. Routing rules may also include queuing instructions or prioritization hierarchies. For example, a routing rule may state that all UDP packets take priority over TCP packets. Similarly, a routing rule may state that all packets from Ethernet port 2 take priority over packets from port 22.

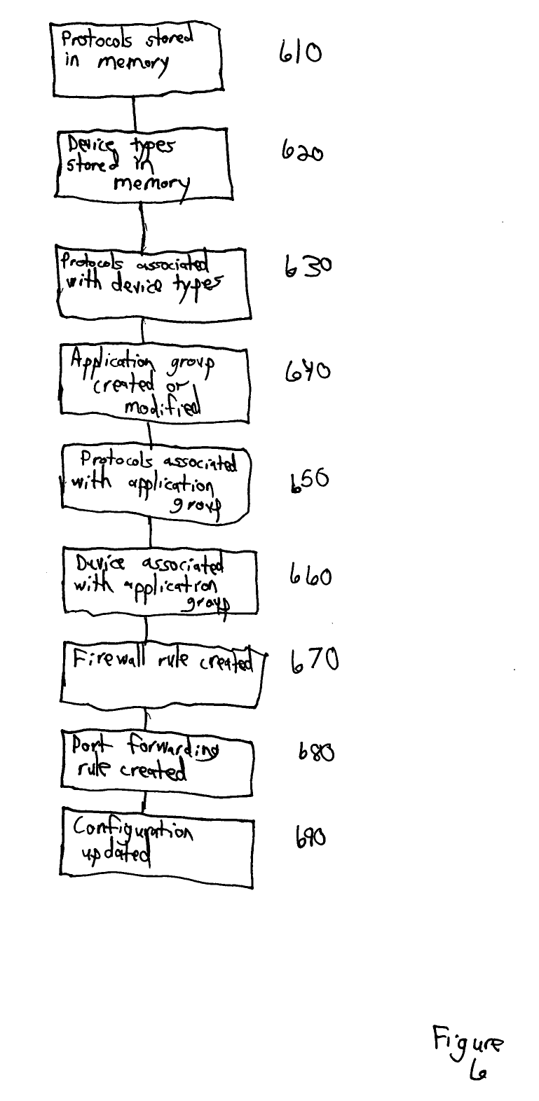

Application database 60 includes a database of application groups 62 created in accordance with the process described relative to FIG. 6. Application groups 62 are groups of applications for which rules or parameters may be set for the group as a whole. Application groups 62 may have common or similar protocols with which they communicate over a network such as network 20. In one embodiment, application groups 62 may be applications for which a user desires to create common rules or parameters such as, for example, a quality of service class. Application database 60 may also include lists of known application types that may be desirable to group with other applications. Application database 60 may additionally include layer 7 or layer 4 protocols. Application database 60 may further include common rules that a user may wish to apply to particular types of applications. Application database 60 may also include preexisting templates 64 of application groups for particular types of applications, particular protocols, particular versions of network devices, particular business types, or any combination of the foregoing. In such a manner, in one embodiment, configuration server 10 may automatically select a particular template 64 most suitable for a particular customer, network device, or type of application. Alternatively, a particular template 64 may be selected by a user such as a network administrator, network provider representative, or customer. Templates 64 may include fields that are changeable by a user. Templates 64 may also include fields that are not changeable by a user.

Network 20 is a data network such as an internet protocol network. Alternatively, network 20 may be any network suitable for the communication of voice, data, or other content. Network 20 may be one or more private or public networks using dedicated or switched links. For example, in one embodiment configuration server 10 may be one or more servers or computers that communicate using a private network. Configuration server 10 and routers 30, 40, and 50 may also communicate using a public network such as the Internet whether connecting directly to the Internet, or indirectly via links in a wired or wireless network such as a cellular network. Each of the communications links making up network 20 may be implemented using fiber, cable, twisted-pair, satellite, radio, microwave, laser or other suitable wired or wireless links.

Routers 30, 40, and 50 are routers connected to network 20. Each of routers 30, 40, and 50 are network devices that utilize dedicated or switched lines to connect other network components. In particular, routers 30, 40, and 50 assist in finding the best route between any two network points and may determine the next network point to which a data packet should be forwarded in route to its destination. Routers may maintain a table of available network routes and use the information in such tables to determine the best route for a particular data packet. Router 50 illustrates a particular router that is configured according to the teachings of the present invention. In particular, router 50 may be preconfigured by storing a domain name 52 associated with configuration server 10 and an address associated with the network address of router 50. Although not illustrated, routers 30, 40 and 50 may also include memory and processing resources such as those described relative to memory 12 and processor 14 of configuration server 10.

Although not illustrated, routers 30, 40, and 50 may include multiple memory and processing components like memory 12 and processor 14. In one embodiment, any of routers 30, 40, and 50 may include a plurality of Pentium® or other suitable processors to significantly enhance the processing power of such router. Such processors, for example, may allow such a router to process data communicated over many different network links simultaneously, enabling such a router to significantly increase the number of customers or user groups serviced by such router.

Also not illustrated, in one embodiment a client that communicates data to or from network 20 may be a personal computer; alternatively, a client of network 20 may be a workstation, terminal, personal computer, web appliance, personal digital assistant, cellular telephone, application specific device, or any other suitable computing or storage device. Such clients may include a web browser or other software and/or hardware interface, volatile or non-volatile memory, processor and/or other processing components, and/or other software, hardware, and peripherals suitable for such computing devices.

In network 20, HyperText Transfer Protocol (HTTP) is used to communicate information between clients and servers. Alternatively, File-Transfer Protocol (FTP), Telnet, Usenet, mobile agents, cookies, paging, electronic mail, instant messaging, bulletin boards, or any other suitable communication techniques may be utilized. Clients may maintain and execute browsers or other suitable parsing programs for accessing and communicating information addressed by Uniform Resource Locators (URLs). Any suitable communications protocol may be implemented alone or in combination with one or more generally available security and/or encryption techniques such as Secure Socket Layer (SSL) protocol to ensure the secure, private communication of data over network 20.

In the illustrated embodiment, network 20 and devices communicating thereon may be implemented in a programming environment that supports access or linking to various sources of information using URL addresses. As such, the content of modules and databases included on servers servicing such network 20 may be constructed using Hypertext Mark-Up Language (HTML), Extensible Mark-Up Language (XML), other forms of Standard Generalized Mark-Up Language (SGML), Virtual Reality Mark-Up Language (VRML), Javascript, or any other appropriate content development language. They may also include program code, such as applets or servlets written in JAVA, or other appropriate self-executing code.

Although the components of configuration server 10 and router 50 are illustrated or described in this FIG. 1 as separate databases, modules, subsystems and other illustrated components, each of such separate components may be implemented using a single processor for configuration server 10 or router 50 such that the single processor accesses stored algorithms, executables, and other data that are stored in read-only memory, for example, and executed using random access memory. Likewise, such separate databases, modules, subsystems and other illustrated components may be combined, separated or distributed across one or more processing and/or memory devices. Memory for such databases, modules, subsystems, or other illustrated components of configuration server 10 or router 50 may be implemented using one or more files, data structures, lists, or other arrangements of information stored in one or more components of random access memory, read-only memory, magnetic computer disks, compact disks, other magnetic or optical storage media, or any other volatile or non-volatile memory.

Likewise, it should be understood that any components illustrated or described in FIG. 1 may be internal or external to the illustrated components of FIG. 1, depending on the particular implementation. Also, databases, modules, subsystems or other components may be separate or integral to other components. Any appropriate referencing, indexing, or addressing information can be used to relate back to an address or location of a database, file or object within network 20.

In operation, router 50 may be configured to operate over network 20 using one of configuration scripts 28 that it receives from configuration server 10. In particular, router 50 may download or otherwise receive one of configuration scripts 28 from configuration server 10 and execute the commands included in or identified by such configurations script 28. Such commands may generate the routing rules, firewall rules, and port forwarding rules of such router 50 that are necessary to allow router 50 to operate over network 20.

A configuration script may be automatically applied to a network device such as a router if the configuration script has changed. A hashed comparison may be made between two configuration files, and if they differ, a network device such as a router may install the new configuration.

An example of a configuration of a router is described below:
1: The system makes sure the loop back device is up.
2: System nameservers are set.
3: The device time is synchronized against an NTP Time server
4: System Logging is started (or checked to see if running)
5: Network Address Translation(“NAT”) rules and customer port information are loaded.
On a port-by-port basis the ports and corresponding NAT rules are set up.
IP addresses are added to the customer device.
Customer NAT rules are applied to all private IP addresses.
Private addresses may either be specified or assigned automatically when a contract with a customer is created.
The customer port is then set to ‘up’ and is ready to be used.
If a port is not being used, all IP addresses, corresponding firewall rules, bandwidth management and any other port specific information is removed.
6: DHCP processes are started on a port by port basis. A single IP range can be selected on a customer contract to allow DHCP to be served.
7: Rate limiting and quality of service (QoS) rules are applied.
Step 1: All previous rules are queued to be removed. This is to assure that no other process or program has changed them in a way that cannot be automatically detected.
Step 2: The queuing devices are brought up. Queuing devices are used to send packets to, to make an ‘intermediary step’ inside the router. This allows the device to use “ingress” rules on an egress port. This allows for two way bandwidth limiting within the same device. A normal device can only slow down the rate of packets it sends, but not receives.
Step 3: Basic rate limiting rules are established. A “root” rule is added saying that no bandwidth greater than the fastest interface is allowed. Every rule is applied to both the input queue and the output queue.
Step 4: Per-Firewall redirects are set. Here, each customer's packets are split up into their own mini-firewalls. Each IP address is redirected to the corresponding per-device firewall. So if a customer has the IP address range of 1.0.0.0/24 and is on port 8, a IPTABLES JUMP rule is added saying “All of 1.0.0.0/24 is sent to the firewall table for port 8”. This way, a fully treed firewall is set up, so one port's firewall cannot interfere with another port.
Step 5: Firewall-based classifications are set. Any QoS Defined classes are set. Assumptions for a customer contract are as follows:
Customer purchases 1 Mbit/sec UP, 1 Mbit/sec Down.
Customer has 2 QOS Queues.
Queue 100: HTTP gets 55% of bandwidth (600 KBits/Sec) Reserved, up to a limit of 95% (950 Kbits/Sec). DiffServ Classifier AF21 is Applied to this group.
Queue 200: Voice gets 40% of bandwidth reserved (450 Kbits/Sec), up to a limit of 95% (950 Kbits/Sec) Diffserv classifier EF is applied to this group.
Queue 1: The default queue where all other packets go. This queue is always present and gets 5% Reserved bandwidth (50 Kbits/Sec), up to a limit of 100% (1 Mbit/Sec). The default DiffServ Classifier is AF23, which is applied to this group.
Customer Applies Layer 7 HTTP Matching to Queue 100.
Customer Applies Layer 4 TCP Port 80 Inbound to Queue 100.
Customer applies Layer 7 Group VOICE matching to Queue 200.
Customer applies Layer 7 RTSP (A Member of the Group VOICE) to the default queue of 1.
Here the Router sets up all the Queues (100,200,1) with the IPTABLES CLASSIFY parameter, and then the Diffserv DSCP markers with the IPTABLES DSCP Parameter.
Here the router sets all the HTB Based Kernel Classifier rules with TC (A part of Iproute2). These rules are part of the Linux® kernel subsystem that keep track of how much data is passing through them, and does the actual throttling.
Step 6: Firewall rules are applied.
For each customer, the table of firewall rules is added. These can be simple ACCEPT or DROP rules for layer 7 or any other port/protocol/ip_protocol.
Step 7: Port forwarding Firewall rules are added.
For each customer, the table of PORT forwarding rules is applied. These rules can either be a single port/protocol/or a single protocol and a range of ports using a: (Ex 1:100 is ports 1 through 100).
Step 8: Router Security.
All the rules for accessing the Router are applied. Only the configuration servers may access its NCX Protocol port (Currently TCP:4214). A configuration server setting also allows a SNMP Server to be set that allows access to the UDP SNMP ports.
Step 9: System Defines.
These are the settings that are relevant to the router as defined in the System Settings menu in configuration server. These include things such as: Logging level, Enable OSPF Ring, Monitor_Cycle, Syslog server, Flatline Duration Etc.

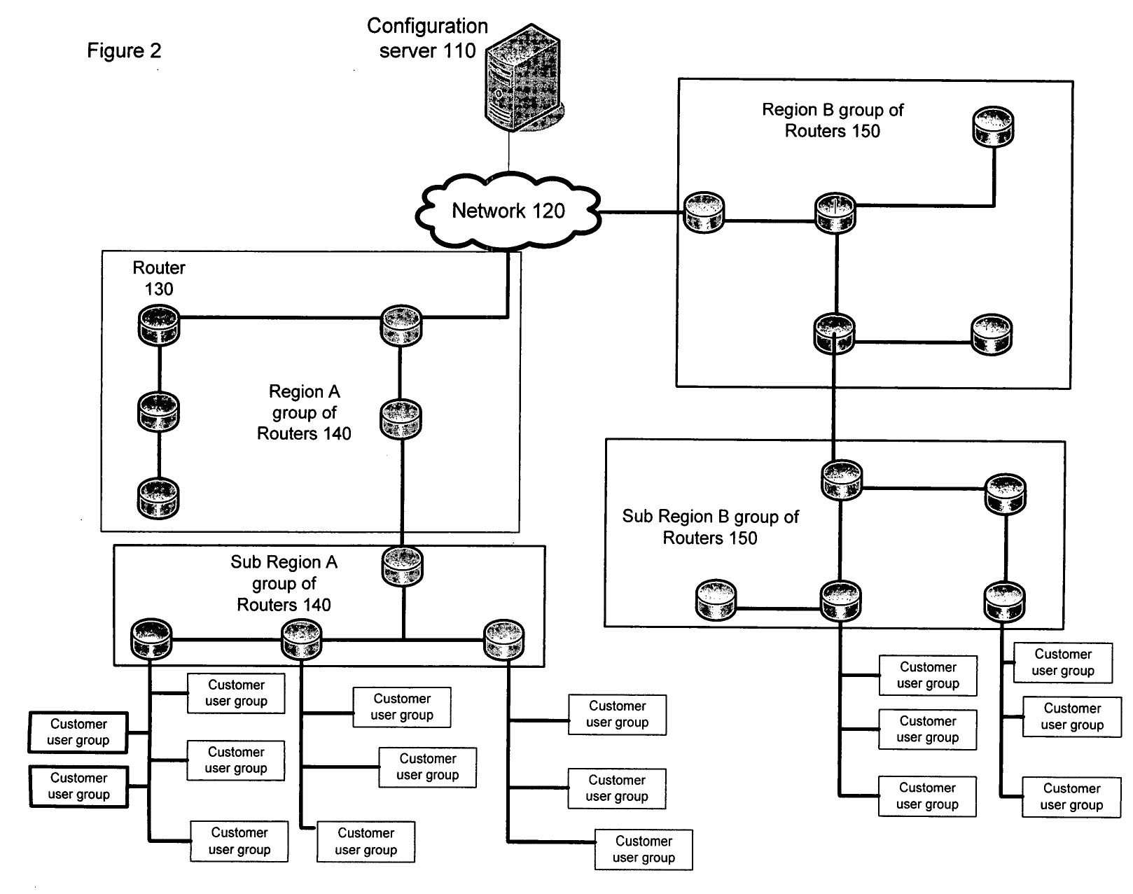

FIG. 2 illustrates an embodiment of a network having multiple regions of routers, one or more of which may be configured according to the teachings of the present invention. In particular, FIG. 2 illustrates a configuration server 110 in communication with a network 120. A region A group of routers 140 and a region B group of routers 150 are also in communication with network 120. Subregion A group of routers 160 communicate with network 120 through the region A group of routers 140. Subregion B group of routers 170 communicate with network 120 through the region B group of routers 150. Both regions A and B and subregions A and B may include routers such as router 130. Router 130 is configurable by executing a configuration script like the configuration scripts disclosed in FIG. 1. In such a manner, customer user groups such as customer user group 180 may connect local area networks or network devices comprising such customer user group to network 120 through a router such as router 130. As discussed in further detail throughout the specification, a router such as router 130 may be easily provisioned according to the teachings of the present invention to allow one or more customer user groups to connect to network 120.

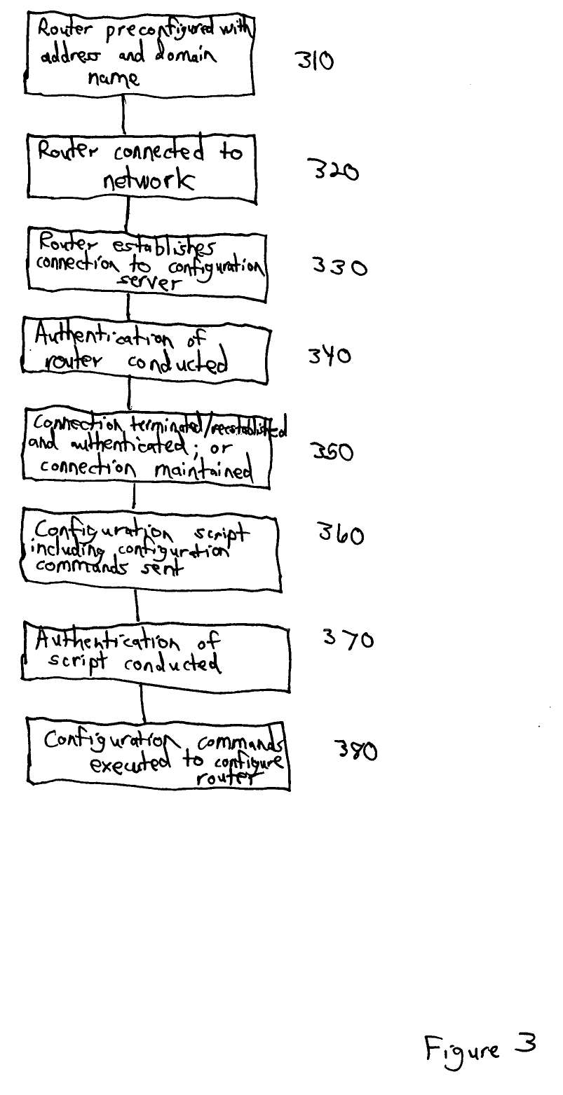

FIG. 3 illustrates an embodiment of a method of configuring a router according to the teachings of the present invention. More particularly, an embodiment of a method of configuring a router is illustrated whereby a router can be automatically configured upon being connected to any network having an active connection to the Internet.

In Step 310, a router is preconfigured with a static IP address corresponding to the router itself, and a domain name system (DNS) domain name of a configuration server. In Step 310, the router may also be preconfigured by identifying the static gateway the device will use to connect to the network and the static subnet on which the device will sit in the network. To preconfigure such router, the foregoing information may be loaded into a memory device of the router.

In Step 320, the router is delivered to wherever it will be utilized and thereafter physically connected to a network to which the configuration server is also connected. Such network may include portions that may or may not be within the control of an operator of the router or the server.

In Step 330, the router establishes a connection to the configuration server over the network. Such connection may be established, for example, by determining the IP address of the server using a public DNS. The connection can then actually be established utilizing standard protocols, such as HTTP and SSL.

In Step 340, the router sends to the server over the established connection an authentication token. Such token may include a cryptographically hashed combination of a previously determined identifier together with address information known to both the router and the server. The server may then perform the same cryptographic hashing function on the same data, and then compare the result to the authentication token submitted by the device. If there is no match following the comparison, the process ends without the delivery of configuration data from the server to the router. If the results match following the comparison, then the router is considered authenticated and the process continues to Step 450. Although Step 340 is described relative to using an authentication token to insure the proper identity of the router by the server, any other suitable data using encryption or cryptography or other suitable means can be utilized to confirm the identity of the router. Alternatively, in an insecure network or a network operating entirely within additional security measures such as a firewall, Step 340 may be skipped entirely or substituted with a mere handshake or acknowledgement process.

In Step 350, the configuration server may terminate the connection to the router. It may then initiate a new connection to the router, using the router's IP address known by it to have been assigned in Step 310 when the router was preconfigured prior to delivery and installation. Upon such connection being established by the server, the authentication procedure described in Step 340 above may be repeated to confirm authentication. Alternatively, the server may not terminate the connection to the device and may instead indicate to the router that the server will provide a configuration script to the router as further described in Step 360 below.

In Step 360, the router requests from the server and the server provides to the router a configuration script. Such configuration script includes a list of commands or a list of identifiers corresponding to commands. Such commands will configure the function and control of the router in order to allow the router to operate over the network.

In Step 370, the router may check the integrity of the configuration script by checking a cryptographic hash of the script against a hash provided by the server. If the results of such comparison match, in Step 380, the router will proceed with executing the commands that are either contained in or indicated by the script.

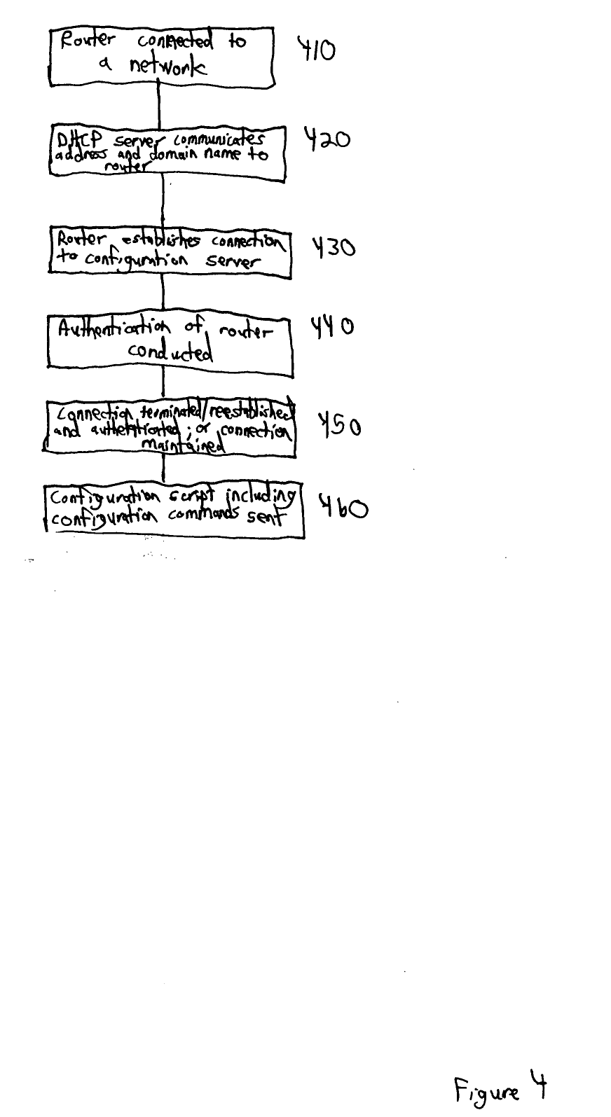

FIG. 4 illustrates yet another embodiment of a method for configuring a router to operate on a network. More particularly, FIG. 4 illustrates a method whereby a router may be configured to operate on a network without any preconfiguration of the router itself. In such an alternative embodiment, any network link to which the router may be connected is a link that is capable of being connected to a server that includes configuration information for the router without passing over any portion of a public or private network that is not within the control of the operator of the server with the configuration data. For example, this method may be used for a router that is physically connected to the network of an internet service provider such that data from a router can be communicated directly to a server of such internet service provider without passing over a public or third party network such as the Internet.

In Step 410, the router is delivered to wherever it will be utilized and thereafter physically connected to a network to which the configuration server is also connected.

In Step 420, a Dynamic Host Configuration Protocol (DHCP) server (within the control of the operation of the server storing the configuration data for the router) communicates to the router the dynamic IP address of the router and the domain name of the server that stores the configuration data for such router. The DHCP server may also communicate additional data such as a dynamic gateway address of the router and the dynamic subnet address of the router.

In Step 430, the router establishes a connection to the configuration server over the network. Such connection may be established, for example, by determining the network address of the server using a public DNS. The connection may then actually be established utilizing standard secured protocols, such as HTTP and SSL.

In Step 440, the router sends to the server over the established connection an authentication token. Such token may include a cryptographically hashed combination of a previously determined identifier together with address information known to both the router and the server. The server may then perform the same cryptographic hashing function on the same data, and then compare the result to the authentication token submitted by the device. If there is no match following the comparison, the process ends without the delivery of configuration data from the server to the router. If the results match following the comparison, then the router is considered authenticated and the process continues to Step 450. Although Step 440 is described relative to using an authentication token to ensure the proper identity of the router by the server, any other suitable data utilizing encryption or cryptography or other suitable process can be utilized to confirm the identity of the router. Alternatively, in an insecure network or a network operating entirely within additional security measures such as a firewall, Step 440 may be skipped entirely or substituted with a mere handshaking or acknowledgement process.

In Step 450, the configuration server may terminate the connection to the router. It may then initiate a new connection to the router, using the router's IP address known by it to have been assigned in Step 410 when the router was preconfigured prior to delivery and installation. Upon such connection being established by the server, the authentication procedure described in Step 440 above may be repeated to confirm authentication. Alternatively, the server may not terminate the connection to the device and may instead indicate to the router that the server will provide a configuration script to the router as further described in Step 460 below.

In Step 460, the router requests from the server and the server provides to the router a configuration script. Such configuration script includes a list of commands or a list of identifiers corresponding to commands. Such commands will configure the function and control of the router in order to allow the router to operate over the network.

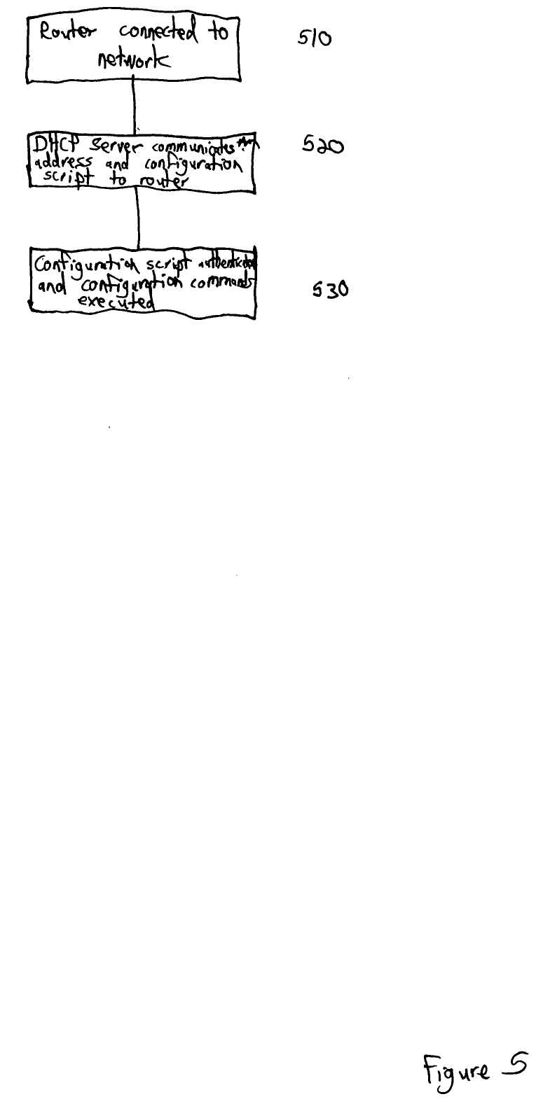

FIG. 5 illustrates yet another embodiment of a method for configuring a router to operate on a network. More particularly, like the method illustrated in FIG. 4, FIG. 5 illustrates a method whereby a router may be configured to operate on a network without any preconfiguration of the router itself. In such an alternative embodiment, any network link to which the router may be connected is a link that is capable of being connected to a server that stores configuration information for the router without passing over any portion of a public or private network that is not within the control of the operator of the server storing the configuration data. For example, such method may be utilized for a router that is physically connected to the network of an internet service provider such that data from a router can be communicated directly to a server of such internet service provider without passing over a public or third party network such as the Internet.

In Step 510, the router is delivered to wherever it will be utilized and thereafter physically connected to a network to which the configuration server is also connected.

In Step 520, a DHCP server within the control of the operator of the server storing the configuration data of the router communicates the dynamic IP address of the router. The DHCP server may also communicate additional information such as the dynamic gateway address of the router and the dynamic subnet address of the router. In such embodiment, the DHCP server may also immediately communicate a configuration script to the router stored on the DHCP server. Upon receipt of the script, the router executes the configuration script, thereby executing the commands necessary to configure the functionality and control of the router necessary to operate on the network.

In Step 530, the router may check the integrity of the configuration script by checking a cryptographic hash function of the script against a hash function provided for by the server. If the results of such comparison match, the router will proceed with executing the commands that are either contained in or indicated by the script.

Although not illustrated herein, in one embodiment a script may be created for a router in response to the router being determined to be connected to the network. In such an embodiment, algorithms, tables, or databases of model configuration commands may be used to generate such script using data communicated from the router to a server such as configuration server 10. For example, a server may receive a network address, a gateway address, and a subnet address from the router. A server may also receive an identifier associated with a particular customer from such router. Using such data, rules can be followed in order to create a configuration script for the router. The configuration script may include commands associated with firewall rules and port forwarding rules. In one embodiment, the algorithms create different commands based on the location of the router in a network. In another embodiment, the algorithms create different commands based on one or more customers associated with such router.

FIG. 6 illustrates a process for creating application groups such that rules, policies, protocols, and other parameters may be set for treatment by a network device, such as a router, of a particular group of applications in Layer 7 of the Open System Interconnection (OSI) model. More particularly, both firewall rules and quality of service parameters may be set to be applicable across an entire category of related applications. Such groups of applications may include, for example, networking applications, peer-to-peer applications, instant messaging and chat applications, voice applications, streaming media applications, gaming applications, email applications, document management applications, or audit and control applications. Each of such application groups may include several applications associated with such group. For example, peer-to-peer applications may include Apple Juice, BitTorrent, Direct Connect, eDonkey, Freenet, Gnutella, Go Boogie, Hotline, Kazaa, Napster, SoulSeek, or Tesla.

The process for creating application groups begins in Step 610. In Step 610, a database or other memory structure is populated with a list of all known protocols used by applications to communicate over a network. Each protocol may include a unique identifier and an optional human readable name or description.

In Step 620, the database may also be populated with a list of device types supported by the network utilizing the application groups. More particularly, the list of device types may include a list of types of routers utilized for a particular network. For example, the list may include routers that are listed by manufacturer and/or model number. Each device type may have a unique identifier and an optional human readable name or description.

In Step 630, one or more of the previously indicated protocols may be associated with the device types that support the one or more protocols. In one embodiment, these may be stored as data pairs of identifiers associated with a device type and a protocol.

In Step 640, an application group is created or modified. A user may actually define a new application group, or may alternatively select an application group that has been previously defined. When creating an application group, a user enters a descriptive name or identifier associated with the group for storage on a database or other memory structure.

In Step 650, a user may then associate one or more protocols for the created or modified application group. For example, protocols utilized within an application group for voice applications may include H.323 voice protocol, RTSP, SIP, Skype to Phone, Skype to Skype, or any other suitable voice protocol. In one embodiment, there may be a limit to the number of protocols a particular application group may include. However, in an alternative embodiment there is no limit to the number of protocols an application group may contain, nor is there any restriction on the number of application groups a particular protocol may be associated with. These associations may again be stored in a database or other memory structure as data pairs with an identifier associated with an application group and a particular protocol.

In Step 660, a user may select a particular device with which to use an application group. Unlike the information in Step 620, which referred to specific device types the system would support, in Step 660 the user is actually selecting specific application groups for a unique device. As a result, a user may enter yet another identifier uniquely associated with a particular device such as a router, a device type for such unique device, and an IP address for such device. This unique device will reference an actual physical device connected to, or intended to be connected to, a network.

In Step 670, a user may create network firewall rules. Such firewall rules can be defined on a global basis, or may be customized and tied to a particular device or device type. Basic information that may be entered for firewall rules include source IP address, source port, destination IP address, destination port, and protocol. In particular, protocol information may identify one or more Layer 7 protocols associated with the firewall rule. Alternatively, the protocol information can identify any Layer 4 protocol to be associated with such firewall rule. In yet another embodiment, the protocol field may be utilized to identify information associated with an application group such that the firewall rule applies to all protocols utilized for any application with such application group. The firewall rule can then be stored in a database or other memory structure in a manner such that it is associated with a particular protocol or application group.

In Step 680, the process identified in Step 670 is repeated to create a port forwarding rule. In such step, only information relevant to port forwarding needs to be entered by a user.

In Step 690, once a configuration for a network device has been modified by a user, a user may utilize the interface to indicate that the particular device should have its configuration updated. Such update can be accomplished through a command sent directly to the device initiated by the input of the user, through a batched process, or automatically by a centralized resource such as a configuration server.

In one embodiment, the process illustrated in FIG. 6 may conducted by a user using a web interface or graphical user interface, whether located on a particular network device or remotely from a network device. Although described primarily with reference to Layer 7 protocols, the process is equally applicable to Layer 4 protocols.

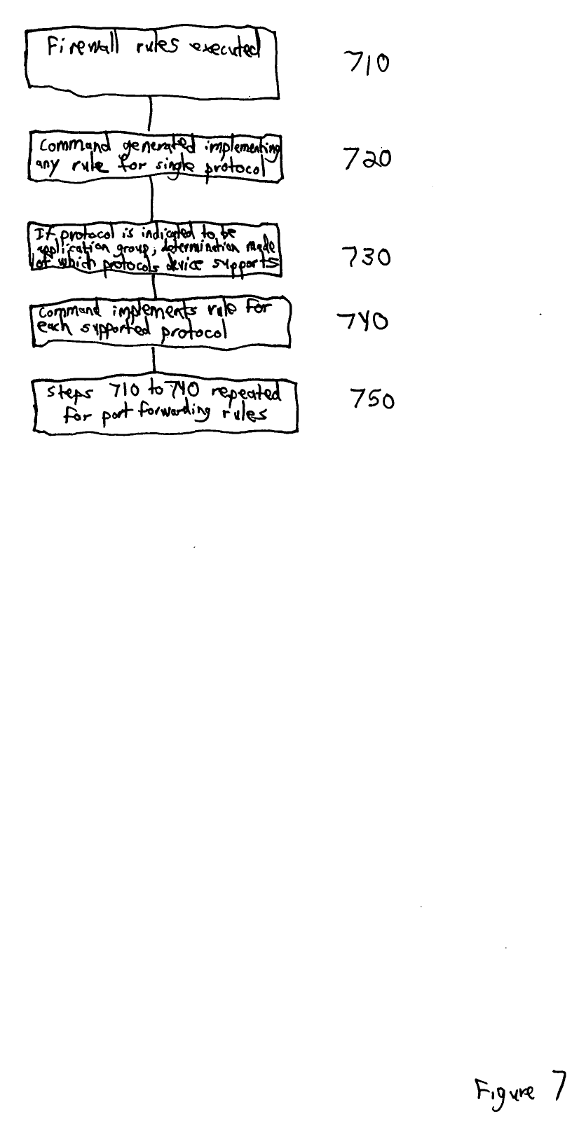

In FIG. 7, a process is illustrated whereby a network device such as a router is configured utilizing an application group. In Step 710, each firewall rule associated with such device is executed. In Step 720, if the protocol field for such firewall rule is a single Layer 4 or Layer 7 protocol, a command is generated by the network device to implement the rule. Alternatively, if the protocol field of the firewall rule indicates that the protocol is an application group, in Step 730 it is determined which protocols included in the application group are supported by this particular network device. In Step 740, a command is generated for the network device to implement the firewall rule for each protocol supported by the network device. In Step 750, all of the above steps are repeated with respect to port forwarding rules in a similar manner to how they were performed with regard to firewall rules.

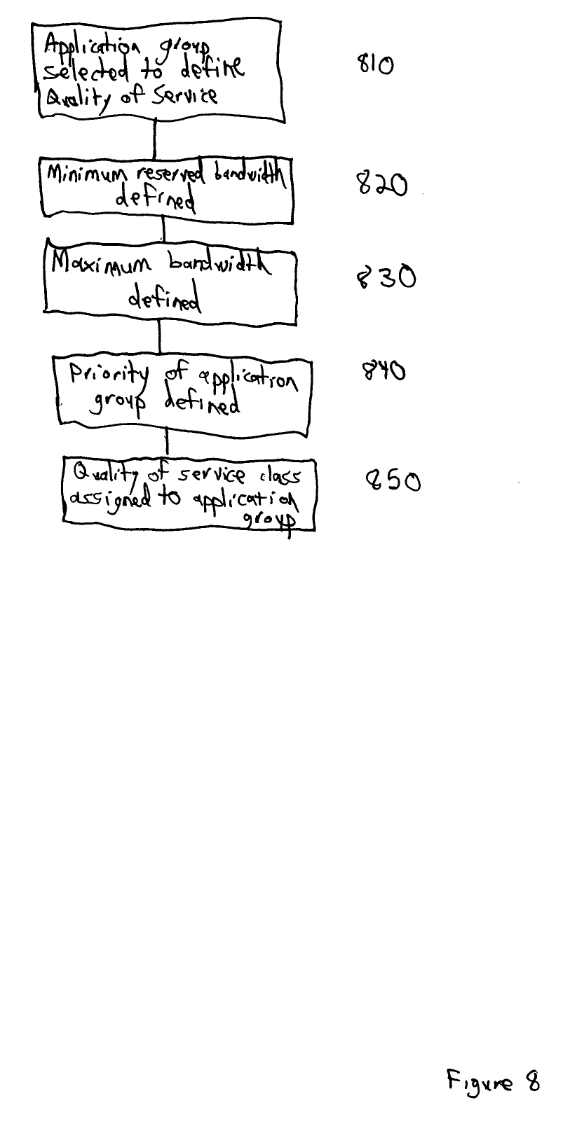

Although not described above, application groups may also be utilized to define quality of service rules and classes applicable to the applications included in a particular application group. FIG. 8 illustrates such definition of quality of service for an application group. In Step 810, a particular application group is selected or created for which to define quality of service. In Step 820, a minimum allocation of bandwidth is defined to be reserved for data communicated by the network device using an application within the application group. In Step 830, a maximum bandwidth is selected such that any data traffic is capped that is communicated by such network device applicable to an application within such Layer 7 application group.

Alternatively, minimum and maximum bandwidth may be set for the communication of data associated with all of the applications within the application group in aggregate. In Step 840, an absolute or relative priority may be set for applications included within an application group. For example, an absolute priority for any data communicated by any application within such application group can be assigned such that the communication of such data takes priority over the communication of the data of any other application or application group now existing or created in the future for such network device. Alternatively, a relative priority may be established for applications within such application group to always take priority or give priority to one or more other particular applications or application groups.

In Step 850, the quality of service class for the individual application or application group is applied and associated with an identifier corresponding to the application group.

In one embodiment, a graphical user interface may be utilized to establish a particular application group. For example, a graphical user interface including a series of pull-down menus may be utilized such that once a particular application group is named or identified, a particular application type such as voice may be selected from a pull-down menu. Once such application type is selected, an additional pull-down menu may be selected that includes potential applications that may be included in the particular application group. Once all of the applications have been selected, particular voice protocols may be selected that are utilized by any of such voice applications. Similarly, network device types such as router model numbers may be selected as being capable of being associated with such application group.

A graphical user interface may also be utilized in the creation of rules such as firewall rules, port forwarding rules, or quality of service classes for the application group. For example, a user may select an option associated with having a firewall rule created that then prompts the user to enter parameters associated with such firewall rule. Likewise, the user may select an option associated with creating a port forwarding rule that then presents the user with similar fields to populate to be used to create such port forwarding rule. Additionally, quality of service rules for a particular application group may be created for the group in aggregate and direct a user to enter a minimum bandwidth, a maximum bandwidth, and some means of setting an absolute or relative priority for network traffic associated with such application group in aggregate. Alternatively, as discussed above, the interface may allow a user to pick particular quality of service classes based on the individual applications included in the application group. For example, the user may elect to have a different quality of service classification applied to one voice application and yet another quality of service classification to apply to a different voice application.

Although the process for creating application groups described above has been presented relative to a user creating a particular application group relative to the particular desires of that individual or the entity for which such individual is establishing service, the above process for establishing application groups may instead be utilized to create templates for application groups that serve as default templates for particular groups of applications such as voice applications, peer-to-peer applications, or any other desirable application groups. In such a manner, such templates can be presented to a user in substantially complete form and allow such user to change only the particular information included in such template that the user does not wish to implement. Similarly, a template may be utilized in combination with one or more user prompts that indicate to a user the desirability of changing one or more of the default rules or other information included within the template for a particular application group. In such a manner, the use of templates or user prompts may be utilized to significantly reduce the expertise of a user required to configure how data communicated by applications are treated by a network device.

The desirability of utilizing application group templates is even more apparent when one considers the different manufacturers and models of network devices such as routers. The process described above may be utilized to create a different template for each router manufacturer or even each router model number. In such a manner, a user need not be familiar with the particular configuration requirements of a specific router and may instead access a template associated with such router and modify only information included within such template that the user does not agree with. Parameters that are not capable of being changed or that are otherwise unavailable for a particular device type may be grayed out or otherwise locked so that a user may not make changes that would disrupt the proper operation of a particular network device.

Other parameters may be set that are associated with particular application groups in addition to those described above. For example, a particular type or level of encryption may be established that is particular to an application group. Such type and level of encryption may be set, for example, in response to the desired security of data being communicated by such applications were in response to the maximum latency that is acceptable when communicating data of such applications.

As previously described above, a particular router or other network device may be utilized by a network provider to service more than one customer. Thus, it is possible that a group of customers sharing a particular network device may have different priorities and requirements in communicating data through such network device. As a result, different firewall rules, port forwarding rules, application groups, and quality of service classes for applications may need to be set for each customer. Thus, configuration rules may need to be established and differentiated for each customer as opposed to or in addition to each network device. Thus, each of the previously described sets of configuration data and/or application group data may need to be associated with a particular customer identifier. In fact, the above processes can easily be implemented in an application utilized to create or manage a customer account. For example, the foregoing process can be integrated with establishing a customer account identification number, customer contact information, customer billing information, and customer requirements. Further, the configuration of a router or other network device servicing a customer may be set up by an account representative of a network provider who also utilizes an interface to create application groups and quality of service classes for such customer based on a survey or input form to which a customer has provided feedback.

The processes for configuring routers in FIGS. 3 through 5 may also be utilized to configure global settings for one or more regions of a network provider or a particular customer for an enterprise utilizing a network. For example, more than one router may be utilized by a network provider to service a particularly large customer. Rather than defining the configuration for each router individually, a user may instead define the configuration for each router included within a particular region as illustrated in FIG. 2. In such a manner, all of the routers servicing such region may be configured utilizing the same configuration script.

Once a global setting for the configuration of all the routers in a particular region have been established, a user may override particular settings for particular devices within such region thereby creating differences between the routers in a particular region.

Each region may in turn include a number of sub-regions. Thus, a user may set configuration commands specific to all of the network devices within such sub-region that are different from the network devices in the region as a whole. Thus, a global region of network devices may have some settings that are common to all network devices within such region and have other settings that differ based on which sub-region an individual network device is associated with. Further, sub-regions may include further sub-regions to further customize groups of network devices with settings that differ from a global or regional setting.

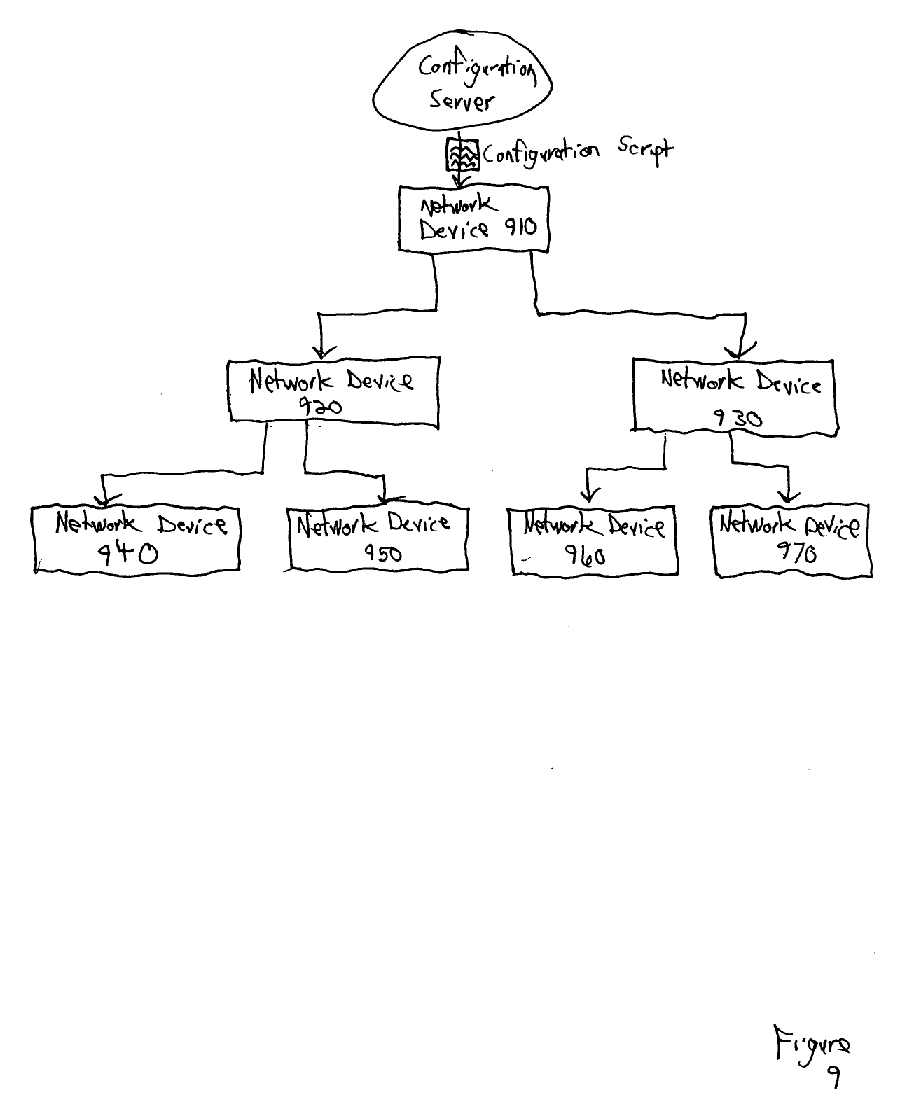

In one embodiment of a network illustrated by FIG. 9, a tree structure of network devices is utilized. In such a structure, a device 910 may take its configuration from a central network resource such as a network configuration server. Devices 920 and 930, which are downstream from device 910, may take their configuration from a network resource such as a configuration server or, alternatively, may take their configuration from any upstream device such as network device 910. In such a manner, network device 910 may be thought of as a distribution node, as it is capable of further distributing network configurations to downstream network devices. As illustrated, devices 920 and 930 are each further connected to devices 940 and 950 and devices 960 and 970 respectively, thus, devices 920 and 930 are also distribution nodes. Devices 940, 950, 960 and 970 are referred to herein as leaf nodes because there are no further downstream devices for which they need to maintain a configuration script.

Utilizing the structure illustrated in FIG. 9, in one embodiment to preserve network bandwidth, when a device needs to acquire a new configuration, the device may first attempt to acquire its configuration from the nearest upstream distribution device. If such configuration is unavailable from the nearest upstream device, the configuration may be sought from other upstream devices or a central resource such as a configuration server. In another embodiment intended to obtain the most current configuration, a device may instead initially query the next upstream device seeking an updated configuration. Such upstream device passes the request to the next upstream device. This continues up the stream until a distribution device is unable to contact the next upstream device. The last distribution device that has been successfully contacted then delivers the configuration to the device seeking its configuration. In such a manner, a new configuration may be acquired even if the configuration server or other central network resource is busy or unavailable. Alternatively as described above, a device may be configured via communication with only the device immediately upstream to the device needing a new configuration, thereby preserving bandwidth.

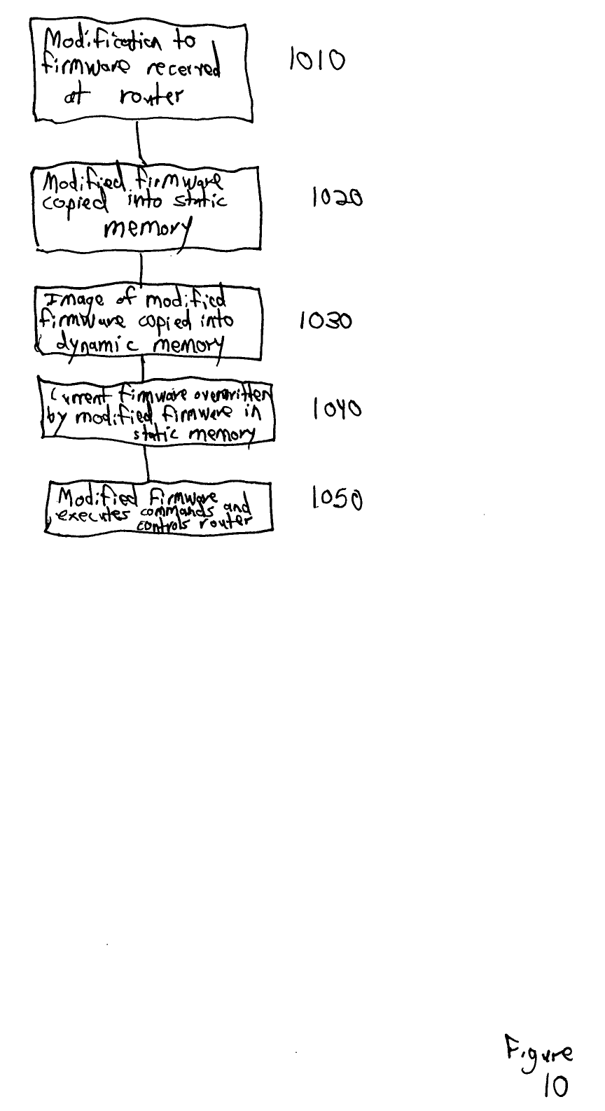

FIG. 10 illustrates on embodiment of a method of modifying the configuration of a router without requiring that a router be rebooted, powered down, or otherwise reinitialized. In one embodiment such a router may be configured without being rebooted, powered down, or otherwise reinitialized using a Linux® kernel. In particular, in step 1010, a modification to the firmware of a router is received from a configuration server, other network device, or directly input into an interface or memory device of the router. The modification may include a change to the configuration of the router. In step 1020, a new version of the firmware incorporating the configuration changes is copied into the static memory of the router. In step 1030, the image of the new version of the firmware is transferred into dynamic memory of the router. In step 1040, the current firmware is overwritten in memory utilizing the new version of the firmware stored in dynamic memory. Such overwriting may be accomplished utilizing identity mapping. In step 1050, the new firmware establishes control of the router.

The use of the foregoing process allows one to skip the extensive reboot time normally required when reconfiguring a router. As systems become more advanced and complex in terms of processor speed, memory size and resource capacities, reboot times have actually become longer. While a longer reboot time is typically an irritant in any case, its impact in a production system such as a network needing to minimize downtime can be critical. In particular, the most time consumed during a reboot process is normally during the firmware stage, where devices attached to the system are recognized and initialized. The above method may be used to avoid the time needed to perform any hardware reset, firmware operation, or shutdown of the previously running router. As a result, time spent terminating running processes, writing back cash buffers to disk, unmounting file systems, and performing the hardware reset may be avoided. In such a manner, the bootloader stage of switching firmware can be avoided and only the kernel stage of switching firmware needs to be conducted.

Although in one embodiment the above method of changing the configuration of a router is used with a router utilizing a Linux® kernel, the process may be utilized with any kernel or firmware that does not require rebooting after establishing a new version of the kernel or firmware. One characteristic of many such kernel or firmware versions not requiring such rebooting is the ability of the new kernel or firmware to sit in the same place in memory as the previously executing one.

While, in the foregoing, the present invention has been described in accordance with specific embodiments, those skilled in the art would appreciate that variations of these embodiments fall within the scope of the invention. As a result, the invention is not limited to the specific examples and illustrations discussed above.

We claim:

1. A method of forming an application group, the method comprising:
selecting a plurality of applications to be associated with an identifier; and
determining at least one rule associated with the identifier, the rule operable to define at least one operation of a network device that is conducted in response to the network device receiving data associated with one of the plurality of applications.

2. The method of claim 1, and further comprising selecting one or more protocols operable to be used by at least one of the plurality of applications to communicate data over a network.

3. The method of claim 1, wherein determining the at least one rule comprises determining at least one routing rule.

4. The method of claim 1, wherein determining the at least one rule comprises determining at least one firewall rule.

5. The method of claim 1, wherein determining the at least one rule comprises determining at least one port forwarding rule.

6. The method of claim 1, wherein selecting the plurality of applications includes selecting a template that includes a plurality of applications.

7. The method of claim 1, wherein determining at least one rule comprises selecting at least one rule from a list of rules.

8. A system for using application groups to configure a router, the method comprising:
an application group database, the application group database operable to store at least one application group, the application group being associated with a plurality of applications and an identifier;
a configuration script database, the configuration script database operable to store at least one configuration script, the configuration script including a command operable to implement at least one rule associated with the identifier, the at least one rule operable to define at least one operation of a network device that is conducted in response to the network device receiving data associated with one of the plurality of applications included in the application group; and
a processor operable to select the configuration script in response to receiving a request to configure the network device.

9. The method of claim 8, and further comprising one or more protocols operable to be used by at least one of the plurality of applications to communicate data over a network.

10. The method of claim 8, wherein the at least one rule is a routing rule.

11. The method of claim 8, wherein the at least one rule is a firewall rule.

12. The method of claim 8, wherein the at least one rule is a port forwarding rule.

13. The method of claim 8, and further comprising a template for an application group that includes a plurality of applications.

14. A method of creating an application group, the method comprising:
selecting a plurality of applications associated with an identifier;
further selecting a plurality of protocols associated with the identifier, the plurality of protocols operable to be used by one or more of the plurality of applications to communicate data over a network;
determining a plurality of rules associated with the identifier, the rules operable to define at least one operation of a network device that is conducted in response to the network device receiving data associated with one of the plurality of applications; and
defining a class of service associated with the identifier, the class of service operable to define the amount of bandwidth permitted to be used by the plurality of applications to communicate data.

15. The method of claim 14, wherein determining the plurality of rules comprises determining at least one routing rule.

16. The method of claim 14, wherein determining the plurality of rules comprises determining at least one firewall rule.

17. The method of claim 14, wherein determining the plurality of rules comprises determining at least one port forwarding rule.

18. The method of claim 14, wherein selecting the plurality of applications includes selecting a template that includes a plurality of applications.

19. The method of claim 14, wherein determining the plurality of rules comprises selecting at least one rule from a list of rules.

20. The method of claim 14, wherein determining the plurality of rules comprises selecting at least one load-balancing rule.
